(19) United States
(12) Patent Application Publication
(10) Pub. No.: US 2025/0044209 A1
(43) Pub. Date: Feb. 6, 2025

(54) COMPONENT CONCENTRATION MEASURING DEVICE, COMPONENT CONCENTRATION MEASURING PROGRAM, AND COMPONENT CONCENTRATION MEASURING METHOD

(71) Applicant: HORIBA Advanced Techno, Co., Ltd., Kyoto (JP)

(72) Inventors: Tatsuya NAKAHARA, Kyoto (JP); Takuya ONODA, Kyoto (JP); Kazunori HABU, Kyoto (JP)

(73) Assignee: HORIBA Advanced Techno, Co., Ltd., Kyoto (JP)

(21) Appl. No.: 18/702,053

(22) PCT Filed: Oct. 27, 2022
(86) PCT No.: PCT/JP2022/040152

§ 371 Date: Oct. 4, 2024

(30) Foreign Application Priority Data
Nov. 22, 2021 (JP) 2021-189411
Jun. 24, 2022 (JP) 2022-102114

(51) Int. Cl. G01N 15/06; G01N 15/075

(52) U.S. Cl. CPC G01N 15/0656; G01N 15/075; G01N 2015/0687

(57) ABSTRACT

The present invention is a concentration measuring device for obtaining a concentration of a target component in a liquid sample highly accurately, and includes: an optical measuring unit 2 that measures a spectroscopic spectrum of the liquid sample; an electrochemical measuring unit 3 that electrochemically measures a property value of the liquid sample; and a concentration calculating unit 41 that calculates the concentration of the target component by performing a multivariate analysis that uses the spectroscopic spectrum and the property value as explanatory variables.

### TECHNICAL FIELD

The present invention relates to a component concentration measuring device, a component concentration measuring program, and a component concentration measuring method for measuring a concentration of a target component in a liquid sample.

### BACKGROUND ART

As an example of a method for measuring the concentration of a target component in a liquid sample such as a chemical liquid, absorption spectroscopy has been used, as disclosed in Patent Literature 1. In the absorption spectroscopy, a liquid sample is irradiated with light, and a measurement of a light absorption spectrum (spectroscopic spectrum) of the liquid sample is collected. The absorbance of the liquid sample is then obtained from the light absorption spectrum, and is converted into the concentration of a component, using a calibration curve prepared in advance.

However, the absorption spectroscopy has a disadvantage that there are prominent instrumental errors that are intrinsic to its measurement principle. The instrumental errors herein are variations in the measurements among the individual units of the same model. Such instrumental errors can be attributed to, for example, variations in the light intensity among the light sources, variations in the sensitivity among the detectors, and variations in the mechanical precision among the optical systems of the respective units. Moreover, when the liquid sample contains a plurality of components and there is an overlap in their absorption spectra, it is not quite possible to obtain an accurate measurement of the concentration of the target component.

Furthermore, recently, there are sometimes a demand for a measurement of the concentration of a trace component in the order of ppm. In the manner described above, much importance has come to be placed on improving the accuracy of the concentration measurement of a target component.

### CITATION LIST

### Patent Literature

Patent Literature 1: JP 2014-126529 A

### SUMMARY OF INVENTION

### Technical Problem

The present invention has been made to address the issue described above, and a main object of the present invention is to obtain a concentration of a target component in a liquid sample highly accurately.

### Solution to Problem

A component concentration measuring device according to the present invention is a device for measuring a concentration of a target component in a liquid sample, the component concentration measuring device including: an optical measuring unit that measures a spectroscopic spectrum of the liquid sample; an electrochemical measuring unit that electrochemically measures a property value of the liquid sample; and a concentration calculating unit that calculates the concentration of the target component by performing a multivariate analysis that uses the spectroscopic spectrum and the property value as explanatory variables.

With the component concentration measuring device having the configuration described above, because the concentration of the target component is calculated by performing a multivariate analysis that uses a spectroscopic spectrum of the liquid sample and a property value of the liquid sample as explanatory variables, it is possible to obtain the concentration of the target component highly accurately.

Specifically, because the property value obtained by an electrochemical measurement, which is a measurement approach with smaller instrumental errors, as well as the spectroscopic spectrum are used as explanatory variables of the multivariate analysis, it is possible to reduce the instrumental errors, as compared with the configuration in which the concentration of the target component is obtained by using only the absorption spectroscopy.

Furthermore, because values obtained using a plurality of respective measurement principles (a spectroscopic spectrum and a property value) are used as explanatory variables, it is possible to measure the concentration of the target component highly accurately, even when there is another component with a spectroscopic spectrum overlapping with the spectroscopic spectrum of the target component.

Still furthermore, in order to reduce the effect of drift caused by factors such as a fluctuation in the light source or stray light, the concentration calculating unit preferably calculates a first-order or a second-order derivative of the spectroscopic spectrum with wavelength, and performs a multivariate analysis using the derivative as an explanatory variable.

With this configuration, the measurement accuracy of the target component measurement can be improved, compared with a configuration that uses the absorbance at one wavelength. In the configuration in which the absorbance at one wavelength is used, because the data is of only one point and is not a continuous function, it is not possible to calculate a derivative; it is therefore not quite possible to reduce the effect of drift caused by factors such as fluctuations in the light source and stray light.

At this time, when calculated is the first-order derivative of the spectroscopic spectrum with wavelength, a better SN ratio can be achieved, than that achieved with the second-order derivative. By contrast, when calculated is the second-order derivative of the spectroscopic spectrum with wavelength, it is possible to reduce noise, compared with that achieved with the first-order derivative. It is, therefore, possible to decide which one of the first derivative or the second derivative to use, depending on whether the priority is on the SN ratio or noise.

In order to further improve the measurement accuracy of the target component, the concentration calculating unit preferably performs the multivariate analysis using a value of at least one wavelength in the spectroscopic spectrum, as an explanatory variable.

As a specific embodiment of the electrochemical measuring unit, the electrochemical measuring unit preferably includes a conductivity meter that measures the conductivity of the liquid sample or a pH meter that measures the pH of the liquid sample. Because the conductivity meter and the pH meter both introduce small instrumental errors that are intrinsic to their measurement principles, by using conductivity or pH as an additional explanatory variable of the multivariate analysis, it is possible to reduce the instrumental error, compared with the configuration in which the concentration of the target component is calculated only using the absorption spectroscopy. In particular, when the liquid sample contains a trace component that is conductive, the conductivity meter is preferably used; and when the liquid sample contains a trace component having a correlation with hydrogen ions (H⁺), the pH meter is preferably used.

As a specific embodiment of the electrochemical measuring unit and the concentration calculating unit for further improving the measurement accuracy of the target component, the electrochemical measuring unit preferably includes a conductivity meter for measuring the conductivity of the liquid sample and a pH meter for measuring the pH of the liquid sample, and the concentration calculating unit calculates the concentration of the target component by performing the multivariate analysis using the following equation.

$$C ( concentration ) = \sum ( a ( coefficient ) \times Abs ( absorbance ) ) + b ( coefficient ) \times EC ( conductivity ) + c ( coefficient ) \times pH + R ( residual error term ) \qquad [ Equation 1 ]$$

With the electrochemical measuring unit including a conductivity meter, when the liquid sample contains a component that becomes electrically conductive and a component that does not become electrically conductive, it is possible to obtain separate concentration measurements for such components, even if there is an overlap in their absorption spectra in the spectroscopic spectrum. Specifically, even when the components are indistinguishable only with the spectroscopic spectrum (even when the sample contains components the concentration measurements of which are not possible only with the spectroscopic spectrum), as illustrated in FIG. 3, by using the conductivity as an additional explanatory variable, such components are enabled to have different weights in the respective explanatory variables (corresponding to the concentration regression coefficients of the respective explanatory variables), which provide explanations to the concentrations of the components. In this manner, it becomes possible to obtain separate concentration measurements for the respective components, the absorption spectra of which are inseparable due to the overlap. In FIG. 3, the curve represents the absorbance of the sample; the round points corresponding to the conductivity and pH represent the respective measurements; and the bars represent the numerical representations of the magnitudes of effects that the respective explanatory variables have on the concentration measurements (indicated as “concentration contribution ratio” in the drawing).

With the electrochemical measuring unit including a pH meter, when the liquid sample contains a component having a correlation with hydrogen ions and a component not having a correlation with hydrogen ions, it is possible to obtain separate concentration measurements for such components, even if there is an overlap in their absorption spectra in the spectroscopic spectrum. Specifically, even when the components are indistinguishable only with the spectroscopic spectrum (even when the sample contains components the concentration measurements of which are not possible only with the spectroscopic spectrum), as illustrated in FIG. 3, by using pH as an additional explanatory variable, such components are enabled to have different weights in the respective explanatory variables (corresponding to the concentration regression coefficients of the respective explanatory variables), which provide explanations to the concentrations of the components. In this manner, it becomes possible to obtain separate concentration measurements for the respective components, the absorption spectra of which are inseparable due to the overlap.

Furthermore, a component concentration measuring program according to the present invention is a program for measuring a concentration of a target component in a liquid sample, the component concentration measuring program including: an optical measuring unit that measures a spectroscopic spectrum of the liquid sample; an electrochemical measuring unit that electrochemically measures a property value of the liquid sample; and a concentration calculating unit that calculates the concentration of the target component by performing a multivariate analysis that uses the spectroscopic spectrum and the property value as explanatory variables.

Still furthermore, a component concentration measuring method according to the present invention is a method for measuring a concentration of a target component in a liquid sample, the component concentration measuring method including: measuring a spectroscopic spectrum of the liquid sample; electrochemically measuring a property value of the liquid sample; and calculating the concentration of the target component by performing a multivariate analysis that uses the spectroscopic spectrum and the property value as explanatory variables.

### Advantageous Effects of Invention

According to the present invention, by performing a multivariate analysis that uses a spectroscopic spectrum of a liquid sample and a property value of the liquid sample as explanatory variables, it is possible to obtain a highly accurate concentration measurement of the target component.

### BRIEF DESCRIPTION OF DRAWINGS

FIG. 1 is a schematic diagram illustrating a configuration of a component concentration measuring device according to an embodiment of the present invention.

FIG. 2(a) is experiment data indicating the effect of the instrumental errors, when a calibration curve according to a conventional example is used, and FIG. 2(b) is experiment data indicating the effect of the instrumental errors, when a calibration curve according to a present example is used.

FIG. 3(a) is a graph illustrating concentration contribution ratios when only the absorbance is used, and FIG. 3(b) is a graph illustrating concentration contribution ratios when the absorbance, the conductivity, and pH are used.

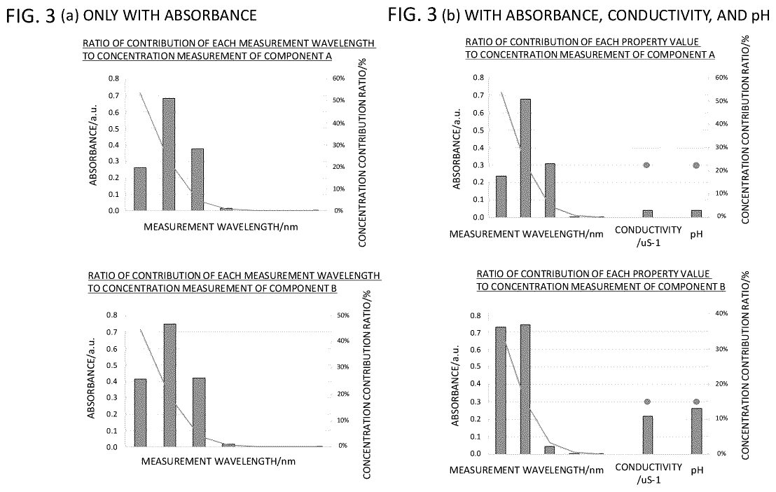

### DESCRIPTION OF EMBODIMENTS

One embodiment of a component concentration measuring device according to the present invention will be described below with reference to the drawings.

### <Device Configuration>

A component concentration measuring device 100 according to this embodiment measures the concentration of a target component in a liquid sample, such as a chemical liquid used in semiconductor manufacturing equipment. The component concentration measuring device 100 is inserted to chemical liquid piping for supplying the chemical liquid, for example, and measures the concentration of a target component in the chemical liquid. The obtained concentration is then used in controlling the concentration of the chemical liquid, for example. The chemical liquid is a mixed chemical liquid (mixed liquid sample) that is a mixture of two or more components, and includes, for example, a component becoming electrically conductive and a component not becoming electrically conductive as the components dissolve, or a component having a correlation with hydrogen ions (H⁺).

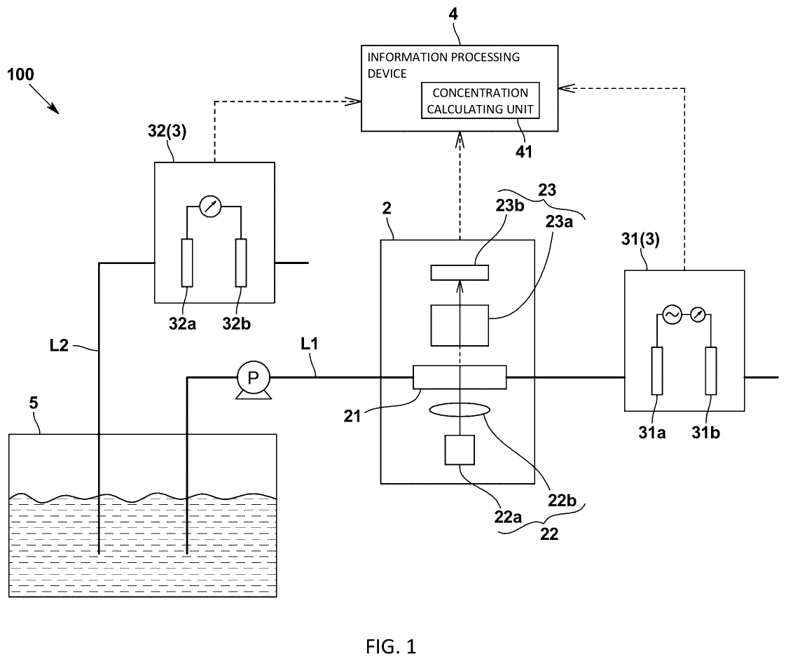

Specifically, the component concentration measuring device 100 includes, as illustrated in FIG. 1, an optical measuring unit 2 that makes a measurement of a spectroscopic spectrum of the liquid sample, an electrochemical measuring unit 3 that electrochemically measures a property value of the liquid sample, and an information processing device 4 that processes the measurement information acquired from the optical measuring unit 2 and the electrochemical measuring unit 3. The property value herein is a value of a physical property having a correlation with the concentration of the target component in the liquid sample.

The optical measuring unit 2 is an absorptiometer that measures the absorbance of the liquid sample, by irradiating the liquid sample with light. Specifically, the optical measuring unit 2 includes: a flow cell 21 through which the liquid sample flows; a light emitter 22 that includes a light source 22a irradiating the liquid sample in the flow cell 21 with light, and a condenser lens 22b; and a light detector unit 23 that includes a spectroscope 23a spectroscopically detecting the light transmitted through the flow cell 21, and a photodetector 23b. With this light detector unit 23, the light absorption spectrum (spectroscopic spectrum) of the transmitted light is obtained. Note that the light absorption spectrum according to this embodiment is a concept including an absorbance spectrum obtained from the light absorption spectrum of the transmitted light and the light absorption spectrum of incident light. The flow cell 21 is provided, for example, to a first sample line L1 formed by the chemical liquid piping (not illustrated) connected to a chemical liquid tank 5 in the semiconductor manufacturing equipment.

The electrochemical measuring unit 3 according to this embodiment includes a conductivity meter 31 that measures the conductivity (electrical conductivity) of the liquid sample, and a pH meter 32 that measures pH of the liquid sample.

Specifically, the conductivity meter 31 applies an AC voltage between two electrodes 31a, 31b, and measures the conductivity (electrical conductivity) of the liquid sample based on the current that flows through the liquid sample. The conductivity meter 31 according to this embodiment is provided to the first sample line L1 where the optical measuring unit 2 is provided, on the upstream or downstream side of the optical measuring unit 2. Note that the conductivity meter 31 may be an AC four-pole conductivity meter or an electromagnetic induction conductivity meter, as well as an AC two-pole conductivity meter. The conductivity meter 31 may also be provided to a sample line other than the first sample line L1.

The pH meter 32 measures pH of the liquid sample based on the potential difference formed between a pH glass electrode (worλing electrode) 32a and a reference electrode 32b. The pH meter 32 according to this embodiment is provided in a second sample line L2 formed by the chemical liquid piping (not illustrated) connected to the chemical liquid tank 5, separately from the first sample line L1. The pH meter 32 may also be provided to the same first sample line L1, on the upstream side or the downstream side of the optical measuring unit 2, for example.

The information processing device 4 calculates the concentration of the target component in the liquid sample, using the light absorption spectrum (or absorbance spectrum) obtained by the optical measuring unit 2, the conductivity obtained by the conductivity meter 31, and the pH obtained by the pH meter. The information processing device 4 is a computer including a CPU, a memory, an input/output interface, an AD converter, and an output unit such as a display, and an input unit such as a keyboard. The CPU and the peripheral devices cooperate with one another to exert a function as the concentration calculating unit 41, based on a component concentration calculation program stored in the memory.

Specifically, the concentration calculating unit 41 calculates the concentration of the target component through a multivariate analysis that uses the light absorption spectrum and the property values (the conductivity and pH) as explanatory variables. As the multivariate analysis, a multiple regression analysis (MLR or ILS), a principal component regression analysis (PCR), a least squares method (CLS), or a partial least squares method (PLS (PLS1 or PLS2)) may be used, for example.

The concentration calculating unit 41 calculates a first-order derivative or a second-order derivative of the light absorption spectrum, and performs a multivariate analysis using the derivative as an explanatory variable. The concentration calculating unit 41 also performs a multivariate analysis using the value of the light absorption spectrum at each of the plurality of wavelengths, an explanatory variable.

Specifically, the concentration calculating unit 41 calculates the concentration of the target component through the multivariate analysis using the following equation.

$$C ( concentration ) = {\sum }_{i = 1}^{n} ( {a}_{i} ( coefficient ) \times {Abs}_{i} ( absorbance ) ) + b ( coefficient ) \times EC ( conductivity ) + c ( coefficient ) \times pH + R ( residual error term ) = ( {a}_{i} , b , c , R ) \cdot ( \begin{matrix}{Abs}_{i} ( absorbance ) \\ EC ( conductivity ) \\ pH \\ R ( residual error term )\end{matrix} ) = k \cdot S \qquad [ Equation 2 ]$$

Where Absᵢ (absorbance) is obtained by taλing a derivative of the light absorption spectrum, and corresponds to a value at each of a plurality of wavelengths (λ1, ζ2, . . . λn).

The coefficients aᵢ is a concentration regression coefficient for the wavelength λi; the coefficient b is a concentration regression coefficient for the conductivity; and the coefficient c is a concentration regression coefficient for pH. These concentration regression coefficients correspond to the weights of the respective explanatory variables.

k is a calibration curve obtained in advance; and S is measurement data (actual measurement data) of the liquid sample, collected with the optical measuring unit 2 and the electrochemical measuring unit 3. The calibration curve is obtained by performing a multivariate analysis using the equation indicated above, on the measurement data measured by the optical measuring unit 2 and the electrochemical measuring unit 3, from a reference sample the concentration of which is known.

When the absorbance and the conductivity are to be used as two explanatory variables, the pH term in Equation 1 above may be set to zero; and when the absorbance and the pH are to be used as two explanatory variables, the conductivity term in Equation 1 above may be set to zero.

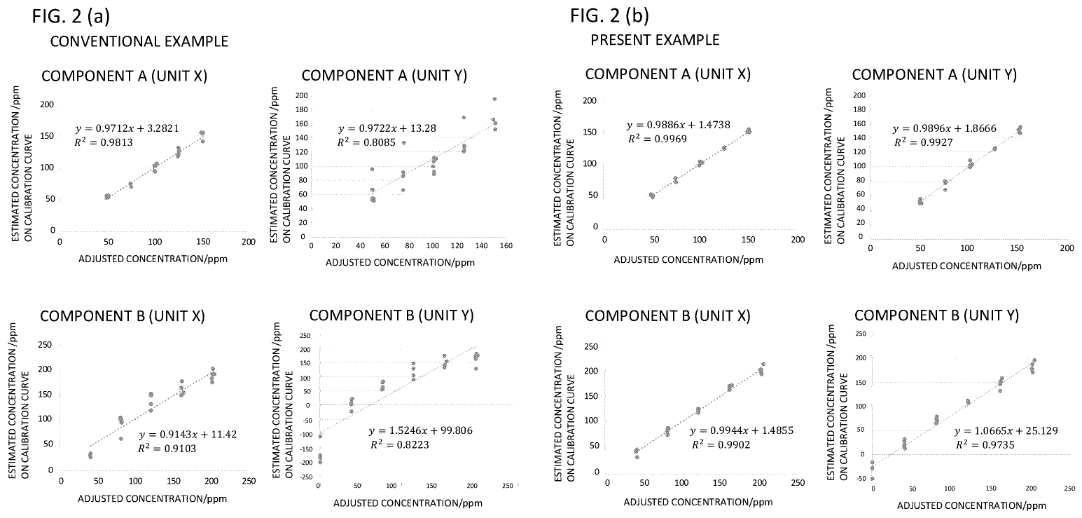

FIG. 2(a) is experiment data indicating the effect of the instrumental errors, when a calibration curve according to a conventional example is used, and FIG. 2(b) is experiment data indicating the effect of the instrumental errors, when a calibration curve according to the present example is used. FIG. 2 is experimental data obtained from a mixed liquid sample that contains two components (a component A and a component B) the concentrations of which are known.

The calibration curves according to the conventional example were prepared using only the light absorption spectrum obtained from the absorptiometer, and the calibration curves according to the present example were prepared using the light absorption spectrum obtained from the absorptiometer, the conductivity obtained from the conductivity meter, and the pH obtained from the pH meter. Both “Unit X” and “Unit Y” indicate concentrations in “ppm”, estimated with the same calibration curves.

As can be seen from FIG. 2, for both “Unit X” and “Unit Y”, the accuracies of the estimated concentrations were improved by using the calibration curve of the multivariate analysis according to the present example, compared with those achieved by using the calibration curve according to the conventional example. The instrumental errors between “Unit X” and “Unit Y” were also eliminated.

### Advantageous Effects Achieved by Embodiment

With the component concentration measuring device 100 having the configuration described above, because the concentration of the target component is calculated through a multivariate analysis that uses a light absorption spectrum (spectroscopic spectrum) of a liquid sample and a property value of the liquid sample as explanatory variables, it is possible to obtain the concentration of the target component highly accurately.

Specifically, because the property value obtained by an electrochemical measurement, which is a measurement approach with smaller instrumental errors, as well as the light absorption spectrum (spectroscopic spectrum) are used as explanatory variables of the multivariate analysis, it is possible to reduce the instrumental errors in the estimated concentrations, as compared with the configuration in which the concentration of the target component is obtained by only using the absorption spectroscopy, and the concentration of the target component can be obtained highly accurately without dependency on the individual units.

Furthermore, because values obtained using a plurality of respective measurement principles (a spectroscopic spectrum and a property value) are used as explanatory variables, it is possible to measure the concentration of the target component highly accurately, even when there is another component with a spectroscopic spectrum overlapping with the spectroscopic spectrum of the target component.

### OTHER EMBODIMENTS

The present invention is not limited to the embodiment described above.

For example, the explanatory variables of the multivariate analysis may also include a temperature or a physical property value of the liquid sample, the physical property value being measured with an instrument that uses a measurement principle different from the electrochemical measurement, in addition to the spectroscopic spectrum and the property value from the electrochemical measurement.

Furthermore, it is also possible to use any one of conductivity and pH as the property value of the electrochemical measurement, or to use refractive index, viscosity, chromaticity, alkalinity, acidity, ORP, water hardness, turbidity density, or ion concentration other than hydrogen ion, in addition to the conductivity or the pH, as the property values. It is also possible to use ultrasonic signal intensity, a flow rate, or a pressure as an additional property value.

Furthermore, in the above embodiment, the multivariate analysis is performed using a derivative of the spectroscopic spectrum as the explanatory variable, but the multivariate analysis may be performed using the spectroscopic spectrum as the explanatory variable, without calculating a derivative of the spectroscopic spectrum.

For example, although the optical measuring unit according to the embodiment is a system for irradiating the flow cell 21 (sample) with white light, and spectralizing and detecting the light transmitted through the flow cell 21 (sample), it is also possible to use a system for spectralizing the white light before the flow cell 21 (sample) is irradiated therewith, and irradiating the flow cell 21 (sample) with the spectralized light, while changing the wavelength with which the flow cell 21 (sample) is irradiated, for example.

The optical measuring unit 2 according to the embodiment described above is an absorptiometer, but may be another type of instrument that measures the spectroscopic spectrum of a liquid sample. The optical measuring unit 2 may be an ultraviolet/visible light spectrophotometer, an infrared spectrophotometer, a Fourier transform infrared spectrophotometer (FTIR), a non-dispersive infrared spectrophotometer (NDIR), a near infrared spectrophotometer (NIR), an inductively coupled plasma atomic emission spectrometer (ICP-AES), an X-ray fluorescence spectrometer, an X-ray absorption spectrometer (XAFS), a nuclear magnetic resonator (NMR), or a Fourier transform nuclear magnetic resonator (FT-NMR), for example. Furthermore, the component concentration measuring device according to the embodiment described above has a configuration in which one type of optical measuring unit is used. However, the component concentration measuring device may have a configuration that uses two or more types of optical measuring units.

The present invention is not limited to the embodiment described above, and it should be needless to say that other various modifications may be made within the scope not departing from the gist of the present invention.

### INDUSTRIAL APPLICABILITY

According to the present invention, it is possible to obtain a concentration of a target component in a liquid sample highly accurately.

### REFERENCE SIGNS LIST

100 component concentration measuring device
2 optical measuring unit
3 electrochemical measuring unit
31 conductivity meter
32 pH meter
41 concentration calculating unit

1. A component concentration measuring device for measuring a concentration of a target component in a liquid sample, the component concentration measuring device comprising:
an optical measuring unit that measures a spectroscopic spectrum of the liquid sample;
an electrochemical measuring unit that electrochemically measures a property value of the liquid sample; and
a concentration calculating unit that calculates the concentration of the target component by performing a multivariate analysis that uses the spectroscopic spectrum and the property value as explanatory variables.

2. The component concentration measuring device according to claim 1, wherein the concentration calculating unit calculates a first-order derivative of the spectroscopic spectrum, and performs a multivariate analysis using the derivative as an explanatory variable.

3. The component concentration measuring device according to claim 1, wherein the concentration calculating unit calculates a second-order derivative of the spectroscopic spectrum, and performs the multivariate analysis using the derivative as an explanatory variable.

4. The component concentration measuring device according to any one of claims 1 to 3, wherein the concentration calculating unit performs the multivariate analysis using a value of at least one wavelength in the spectroscopic spectrum, as an explanatory variable.

5. The component concentration measuring device according to any one of claims 1 to 4, wherein the electrochemical measuring unit includes a conductivity meter that measures conductivity of the liquid sample or a pH meter that measures pH of the liquid sample.

6. The component concentration measuring device according to any one of claims 1 to 5, wherein the electrochemical measuring unit includes a conductivity meter that measures conductivity of the liquid sample and a pH meter that measures pH of the liquid sample, and
the concentration calculating unit calculates the concentration of the target component by performing the multivariate analysis using a following equation:
$$C ( concentration ) = \sum ( a ( coefficient ) \times Abs ( absorbance ) ) + b ( coefficient ) \times EC ( conductivity ) + c ( coefficient ) \times pH + R ( residual error term ) \qquad [ Equation 1 ]$$

7. The component concentration measuring device according to any one of claims 1 to 6, wherein the liquid sample contains a component that becomes electrically conductive and a component that does not become electrically conductive.

8. The component concentration measuring device according to any one of claims 1 to 7, wherein the liquid sample contains a component having a correlation with hydrogen ions and a component not having any correlation with hydrogen ions.

9. A component concentration measuring program for measuring a concentration of a target component in a liquid sample, the component concentration measuring program comprising:
an optical measuring unit that measures a spectroscopic spectrum of the liquid sample;
an electrochemical measuring unit that electrochemically measures a property value of the liquid sample; and
a concentration calculating unit that calculates the concentration of the target component by performing a multivariate analysis that uses the spectroscopic spectrum and the property value as explanatory variables.

10. A component concentration measuring method for measuring a concentration of a target component in a liquid sample, the component concentration measuring method comprising:
measuring a spectroscopic spectrum of the liquid sample;
electrochemically measuring a property value of the liquid sample; and
calculating the concentration of the target component by performing a multivariate analysis that uses the spectroscopic spectrum and the property value as explanatory variables.
